(19) United States
(12) Patent Application Publication
(10) Pub. No.: US 2010/0005382 A1
(43) Pub. Date: Jan. 7, 2010

(54) Method And System For Recording Asset Installations

(75) Inventors: Richard C. Curran, Richmond Hill (CA); Scott D. Hicks, Underhill Center, VT (US); James A. Martin, Endicott, NY (US); Douglas G. Murray, Johnson City, NY (US); Jeffrey E. Prince, Bloomfield Hills, MI (US)

Correspondence Address: Weitzman Law Offices LLC, 425 Eagle Rock Avenue, Suite 102, Roseland, NJ, 07068, US

(73) Assignee: International Business Machines Corporation, Armonk, NY (US)

(21) Appl. No.: 12/166,224

(22) Filed: Jul. 1, 2008

(51) Int. Cl. G06F 17/00; G06F 17/30

(52) U.S. Cl. 715/220; 707/100; 707/E17.044

(57) ABSTRACT

A computer-implemented method for recording an asset survey or installation, comprising storing data received from an electronic database in an independent spreadsheet application operable on a portable electronic device, the data including identifying information for new and/or old assets and an employee listing. At least one field of the independent spreadsheet application is prepopulated with a set of data displayed in a drop down menu when the independent spreadsheet application is not operably connected to the asset management database. A variable is selected from the set of data presented in the drop-down menu associated with the at least one field displayed on the independent spreadsheet when the independent spreadsheet application is not operably connected to the asset management database. The selected variable is stored as a record located in a storage worksheet of the independent spreadsheet application when the spreadsheet application is not operably connected to the asset management database. The record is transferred from the independent spreadsheet application to the asset management database in accordance with controls stored in a control worksheet of the independent spreadsheet application that control the manner of exchange of data with the asset management database.

### BACKGROUND

1. Field of the Invention

This disclosure relates generally to recording asset information and, more particularly, to a method and system that allows technicians in the field to record information efficiently and accurately while off-line from the asset management system.

2. Background

When new assets are deployed in the field, the installing technician records information about the assets at the time of installation and often during a survey in advance of the time of installation. Assets such as, but not limited to, desktop computers, laptop computers, printers, network switches, servers, test equipment or manufacturing devices require their unique alphanumeric serial numbers be accurately tracked and associated with other key information. Additionally, the technician must capture information about the new equipment, about the old equipment being replaced, and about the owner/primary user of the equipment. This data is needed to plan the installation work, update asset management systems, to record the work performed by service provider, for use in billing services associated with the installation and removal of equipment, and other asset management or project management purposes. The information required may include and is not limited to: the equipment manufacturer, model number, serial number, description or category of equipment, asset tag number, physical location, building designation, floor number, room number, owner's and the owner's manager's name, e-mail address, phone number, department, or account number.

Gathering this information in the field prior to or at installation is frequently difficult to do accurately and efficiently. Model numbers, serial numbers, and asset tag numbers on equipment are often hard to read due to position on the equipment, lighting conditions, and angle of viewing. Whether these numbers are easily read or not, there are many opportunities for transcription errors, such as confusing zero and the letter O, and so forth. When paper forms are used to record the data, the numbers are transcribed again for entry into data systems, creating another opportunity for error and confusion, particularly if the transcription is manually entered by another person using a faxed or photocopied document. This transcription introduces additional time and labor to the process, as well as a much greater probability for errors. Any errors created in the process that are not caught and corrected result in permanently incorrect records. These inaccurate records can lead to losses of assets or inaccurate legal and financial information.

### BRIEF SUMMARY

In one aspect of this disclosure, a computer-implemented method for recording an asset installation is disclosed. The method comprises storing data received from an asset management database in an independent spreadsheet application operable on a portable electronic device, the data including identifying information for new assets and an employee listing. At least one field of the independent spreadsheet application is prepopulated with a set of data displayed in a drop down menu when the independent spreadsheet application is not operably connected to the asset management database. A variable is selected from the set of data presented in the drop-down menu associated with the at least one field displayed on the independent spreadsheet when the independent spreadsheet application is not operably connected to the asset management database. The selected variable is stored as a record located in a storage worksheet of the independent spreadsheet application when the spreadsheet application is not operably connected to the asset management database. The record is transferred from the independent spreadsheet application to the asset management database in accordance with controls stored in a control worksheet of the independent spreadsheet application that control the manner of exchange of data with the asset management database.

The foregoing has outlined rather generally the features and technical advantages of one or more embodiments of this disclosure in order that the following detailed description may be better understood. Additional features and advantages of this disclosure will be described hereinafter, which may form the subject of the claims of this application.

### BRIEF DESCRIPTION OF THE DRAWINGS

This disclosure is further described in the detailed description that follows, with reference to the drawings, in which:

FIG. 1 shows an illustrative computer system for exchanging data between a database and an independent spreadsheet operating on a remote portable device in accordance with the present disclosure;

FIG. 2 illustrates an exemplary device record in an asset management database;

FIG. 3 illustrates an exemplary graphical user interface in the spreadsheet application with a drop-down menu displayed for the Unit Model number according to the present disclosure; and

FIG. 4 illustrates a preferred flow diagram according to the present disclosure.

### DETAILED DESCRIPTION

This application discloses a configurable process, system, electronic database and independent spreadsheet application for collecting, updating, storing and maintaining information about old and new assets (e.g., computer equipment), as well as the owner or primary user, physical location, displays and peripherals associated with those assets, the services provided at time of installation, the date and time of the installation, and the name of the service technician. The asset, owner/user information and other data may be imported from available existing sources into an electronic database and exported into an independent spreadsheet application for data entry in the field via drop-down menus, instead of being transcribed or manually entered in the field. Data can be captured in the field electronically, using portable remote devices on which the independent spreadsheet application runs, such as, but not limited to, laptop computers, pocket computers, smart cell phones, or personal digital assistant (PDA) devices.

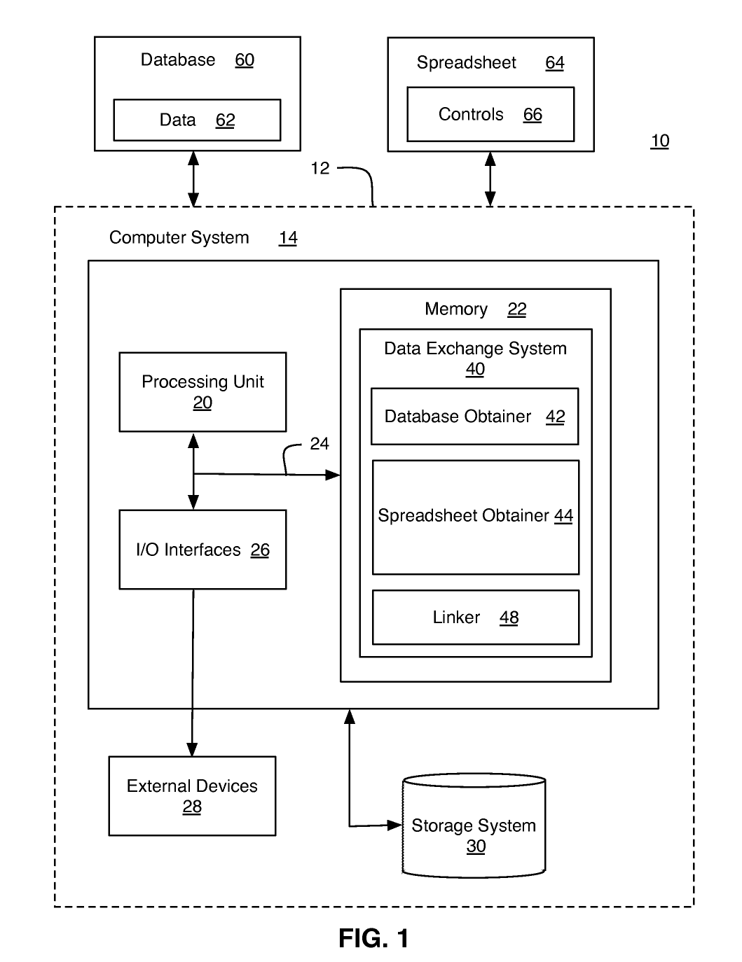

Referring to FIG. 1, an exemplary system 10 is illustrated for exporting data 62 from an electronic database 60 (e.g., an asset management database, an employee database and/or a database with records of recently shipped new equipment) to a spreadsheet application 64 that is running on a portable remote device and/or importing data 62 to the database 60 from the spreadsheet application 64. The spreadsheet application 62 is preferably independent from database 60 so that data may be entered and stored in the field using the portable remote device without the need for the spreadsheet application 64 to be operably connected to the database 60.

The exemplary system 10 preferably includes a computer system 14 deployed within a computer infrastructure 12. Computer infrastructure 12 is illustrative of various types of computer infrastructures for implementing this disclosure and demonstrates that the present disclosure can be implemented within a network environment. For example, in one embodiment, computer infrastructure 12 may include two or more computing devices that communicate over a network to perform various process steps according to this disclosure. Still yet, computer infrastructure 12 may be deployed, managed, serviced and otherwise employed by a service provider that offers to exchange data between a database and an independent spreadsheet.

Computer system 14 preferably includes a processing unit 20, memory 22, bus 24, input/output (I/O) devices/resources 26, external I/O devices/resources 28 comprising any device that enables a user to interact with computer system 14, and system storage 30, all which operate in a conventional manner. The processing unit 20 may include a single processing unit or be distributed across one or more processing units. Similarly, the storage system 30 may comprise a single storage device or be distributed across a network.

Incorporated in memory 22 is preferably a data exchange system 40, which provides the functions of the present disclosure. Data exchange system 40 provides a system for exchanging data between asset management database 60 and spreadsheet 64 that is independent from database 60. Database obtainer 42 obtains data from asset management database 60. Database 60 preferably includes asset and owner/user data 62 that is to be exported to the independent spreadsheet application 64. Spreadsheet obtainer 44 preferably obtains the independent spreadsheet application 64 to which the data 62 from database 60 is exported from and/or imported to.

The database 60 preferably stores data 62 regarding old and new assets, owner and primary users, a listing of employees scheduled to receive new assets, and other data useful in asset management or project management systems. The database 60 may include any type of database management software, such as, for example, Lotus Notes® (a trademark of International Business Machines Corporation), DB2® (a trademark of International Business Machines Corporation), Access® (a trademark of Microsoft Corporation). This disclosure provides a standard, but configurable, process to import, export, manage and present data in and to an independent spreadsheet application 64 for use remotely on a portable electronic device that does not need to access or otherwise be connected to the database 60 at the time of data entry.

Sources of data 62 may include, but are not limited to: (1) an existing asset management database or application that contains information on the existing assets; (2) an employee directory or database that contains information on the owners and primary users; (3) a listing of new equipment that has been shipped to a site for installation; and (4) a migration management database that contains work assignments for the technicians. The listing may, for example, be supplied by the organization that manufactured, staged, or prepared the equipment for installation and would contain relevant information about the new equipment (e.g., serial numbers, model numbers, etc.).

An independent spreadsheet application 64 running on a remote portable electronic device is used to collect, record and store asset data in the field, for subsequent transfer to database 60. Data 62 on new assets to be installed and old assets being replaced at a site, as well as data such as, but not limited to, identifying information for the users or owners scheduled to receive new assets, are exported to a configurable spreadsheet application 64 running on the portable electronic device for remote use. The spreadsheet application 64 may include, for example, Lotus 123® (a trademark of International Business Machines Corporation), Excel® (a trademark of Microsoft Corporation), OpenOffice® (a trademark of Team OpenOffice.org e.V.). The remote portable electronic device may be, for example, a laptop computer, pocket computer, smart cell phone, or PDA.

The spreadsheet application 64 preferably includes at least one tab comprising a plurality of cells or rows for storing data 62 that is exported to and/or imported from the database 60. Data controls 66 are preferably stored in a tab or cell in the spreadsheet application 64 for controlling the exchange of data 62 between the database 60 and the independent spreadsheet application 64. In addition, the data controls 66 may specify parameters for data 62 within a particular cell or within a drop-down list of a particular cell of the front-end form of the spreadsheet application 64.

Linker 48 facilitates the import of data 62 to the spreadsheet application 64 and/or the export of data from the spreadsheet application 64 utilizing the data controls 66. Controls 66 are executed using linker 48 that facilitates the exchange of data 62 between the asset management database 60 and the independent spreadsheet application 64.

The system and method disclosed herein may be used, for example, in surveying existing assets deployed in the field, as well as at the time of installation of new assets and replacement of old assets.

For the former, if a customer has an existing asset management database 60, the existing data 62 from the database 60 may be exported into and stored within a tab of the independent spreadsheet application 64 running on the remote portable electronic device. The front-end form of the independent spreadsheet application 64 may then be prepopulated with the existing data for one workstation at a time. The technician or user performing the on-site survey can then verify the available data, instead of having to collect and enter all data from scratch. The technician or user may also fill in other required fields with new data. When the front-end form of the spreadsheet application is complete, the technician or user may select the “Transfer” button, and all of the data from the front-end form is preferably written to and stored within a row on the results tab of the spreadsheet application 64.

Similarly, at the time of installation of new assets (e.g., equipment) and removal of old assets, data 62 from the database 64 is preferably exported onto one or more tabs on the independent spreadsheet application 64 running on the remote portable electronic device. The tabs may include, but are not limited to: (1) data about the legacy equipment (e.g., owner, location, phone number, machine manufacturer, serial number); (2) data about the new workstations; (3) data about new displays; (4) data about new peripherals (e.g., printers); and/or (5) data about the services required for each workstation (e.g., date and time of day to perform the services, backup and restoration of data, user education).

Data from all the tabs in the independent spreadsheet application 64 is preferably presented on the front-end form of the spreadsheet application either prepopulated or available in drop-down menus. As will be discussed further below, the technician or user may then complete the spreadsheet front-end form or worksheet after completing the installation of the new asset and removal of the old asset, select the “Transfer” button on the spreadsheet application 64, and all data from the spreadsheet front-end form is preferably written to and stored within a row on the results tab of the independent spreadsheet application 64. The front-end form is then cleared for capturing the next record. When all of the surveys or installations have been completed during the assigned work period, the compilation of all the records on the results tab in the independent spreadsheet application 64 is transferred to the database 60 in accordance with controls 66 stored in a control worksheet of the independent spreadsheet application 64 that control the manner of exchange of data with the database 60.

Thus, during site surveys and installation/replacement of assets, the data for variables, such as, for example, model numbers and serial numbers, may be selected by the technician or user from drop-down lists of the pre-populated data set exported from the database 60 contained in the independent spreadsheet application 64. The selected data is stored on the remote portable electronic device and then imported into the database 60 from the spreadsheet application 64 by reconnecting to the database 60 using conventional data transfer methods.

At the time of installation/replacement of assets and/or during site surveys, the technician or user uses the portable electronic device to display a graphical user interface (GUI) on an independent front-end form or worksheet in the spreadsheet application 64. The portable electronic device may be used remotely at the installation site and does not need to be electronically connected to the asset management database 60. The worksheet displays various cells either prepopulated with data or having drop-down menus pre-populated with a data set from the data 62 imported from the database 60 and stored within one or more tabs on the independent spreadsheet application 64 running on the remote portable electronic device.

The technician or user selects the correct information or variable(s) from the drop-down menu(s) for the particular installation at the site and, after making the selections, the user clicks on, taps with a stylus, presses, or otherwise selects the “Transfer” button at the GUI or enters commands specific to the portable electronic device in use. The selected variable is associated with other variables that were prepopulated or entered on a data entry form in the independent spreadsheet application 64 when the spreadsheet application is not operably connected to the database 60. The completed record (e.g., the set of data describing the equipment, the owner, the equipment's location, the date and time of the installation, and the services provided during the installation) is transferred from the data entry form to a results tab or worksheet in another workbook tab on the independent spreadsheet 64, and the data entry form is cleared for capturing the next record. The completed record is preferably stored on a row of the results, which may be invisible to the user. Each time the user makes a transfer of a completed worksheet or front-end form, a new record is created and stored behind the GUI, preferably in another row, on this tab. Additional tabs, which may be invisible to the user, contain controls 66 for, inter alia, controlling the configuration of the front-end form, including the presentation of the data on the front-end form in either prepopulated format or within drop-down menus, and subsequent export to the asset management database.

After installations and/or site surveys are completed (e.g., during the assigned work period), the technician or user may electronically connect the portable electronic device to the asset management system by conventional methods including, but not limited to, the Internet, a wide area network (WAN), a local area network (LAN), a virtual private network (VPN), or to a stand-alone computer containing the asset management database. The compilation of some or all of the completed records stored in results tab in the independent spreadsheet application 64 are preferably exported to the database 60 in accordance with the controls 66 stored in the same tab or under another tabbed worksheet (e.g., control worksheet) that control the manner of exchange of data with the database 60. The database 60 may then store, sort, report, print and perform all other database functions on the records exported from spreadsheet application 64 running on the portable electronic device.

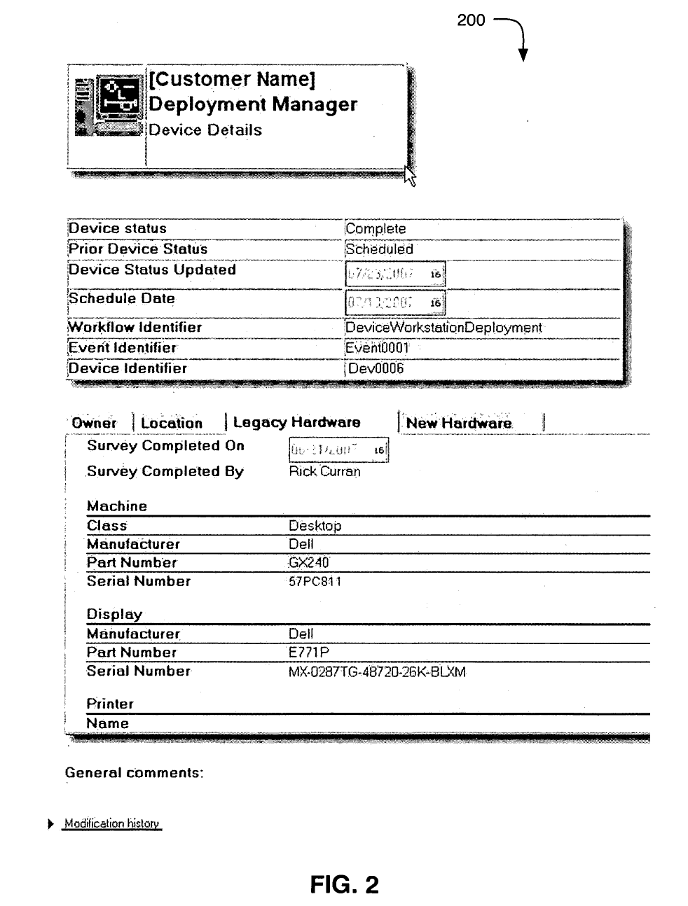

FIG. 2 shows an exemplary device record 200 in an asset management database 60. The device record may show some of the fields at one time, which are displayed in groups according to information type. For example, the old asset (legacy hardware) data are grouped together for display under one tab within the device record 200, the new asset data are grouped for display under another tab within the device record 200, and information about the owner and location are grouped for display under other tabs within the device record 200.

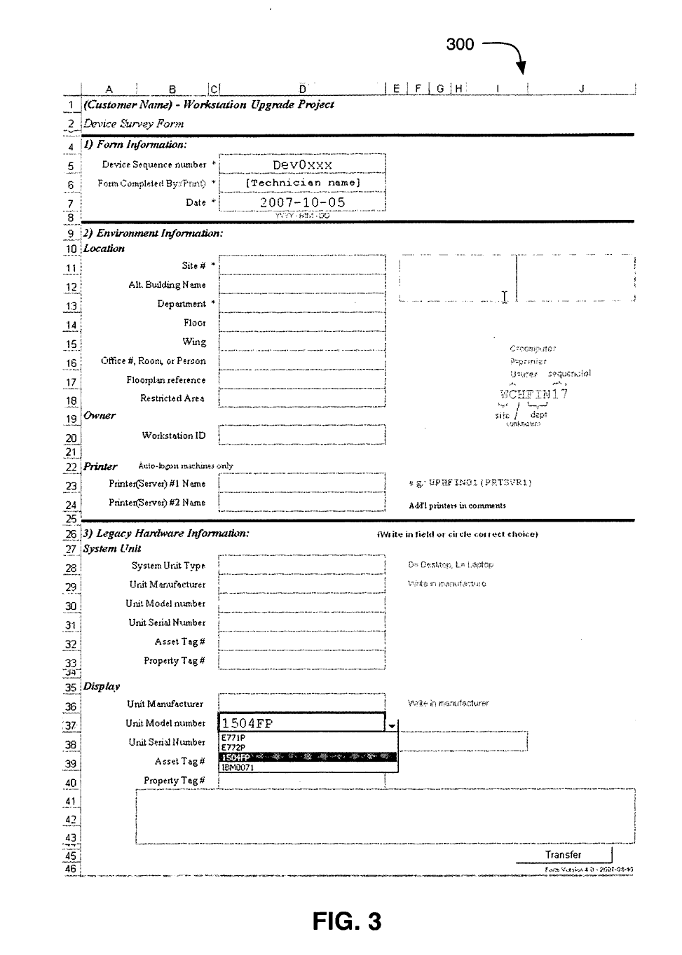

FIG. 3 illustrates an exemplary graphical user interface (GUI) 300 created in the independent spreadsheet application 64 displayed on the remote portable electronic device. Existing data 62 (e.g., data identifying information for new and/or old assets and a listing of employees scheduled to receive new assets) may be exported to and stored within one or more tabs of the independent spreadsheet application 64. The data 62 may be received from electronic database 60 (e.g., an asset management database, an employee database, and/or a database with records of recently shipped new equipment).

Data controls 66, preferably stored under a different tab within the spreadsheet application 64, direct how the imported data 62 is to be displayed by directing the appropriate data to a field within the front-end form of the spreadsheet application 64. The field may be prepopulated with data or variables/members of the set of data belonging to that field may be presented in a drop-down menu for the user or technician to select from. The data 62 is presented in the front-end form of the independent spreadsheet application 64 without the need for the spreadsheet application 64 to be operably connected to the database 60. The user or technician may select the correct variable from the drop-down menu without having to transcribe or manually enter data within the field.

When the user completes the selection, the user may select, click or press the “Transfer” button or enter a command to transfer depending on how commands are input in the particular portable electronic being used. The selected variable is associated with other variables or data that were prepopulated or entered on a front-end data entry form in the independent spreadsheet application 64. This transfers the completed record (e.g., the set of data describing the asset/equipment, the owner, the equipment's location, the date and time of the installation, and the services provided during the installation) from the data entry front-end form to a results tab on the independent spreadsheet 64, and the data entry front-end form is cleared for capturing the next record relating to another asset. When all of the surveys or installations have been completed during the assigned work period, the compilation of all the records on the results tab in the independent spreadsheet application 64 is preferably transferred to the database 60 in accordance with controls 66 preferably stored in a control worksheet of the independent spreadsheet application that control the manner of exchange of data with the database.

The data controls 66, which are preferably stored in one or more tabs in the spreadsheet, may specify a data type, a formatting parameter, a source field, a destination field and/or a formula for a designated cell. Controls 66 may take the form of a sheet control, a column control or a data control. Tools, functions, formulas and macros that are native to spreadsheet applications may be used as controls, or in the alternative, controls may be written in an external language such as, for example, Java (a trademark of Sun Microsystems, Inc.), VisualBasic® (a trademark of Microsoft Corporation), or the like.

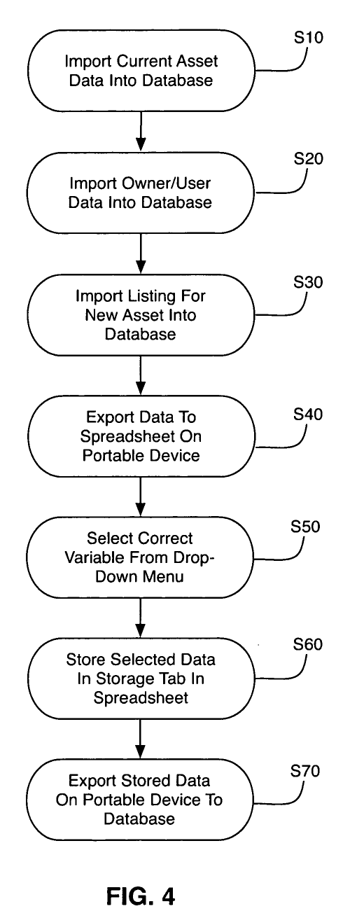

FIG. 4 represents a flow chart of the preferred method according to the disclosure. In step S10, the old asset data is preferably stored in or is imported into the asset management database 60. In step S20, the system 10 preferably imports and stores owner or user data from an employee directory or database. In step S30, the system 10 imports a listing of new assets (e.g., equipment) from the manufacturer or organization that staged or prepared the equipment for installation. In step S40, data 62 from the database 60 (e.g., data identifying information for new and/or old assets and a listing of employees scheduled to receive new assets) is exported to and stored within the independent spreadsheet application 64 on the portable electronic device by conventional electronic communications methods, including, but not limited to, WAN, LAN, VPN or Internet.

In step S50, the user selects the correct variable or variables from the set of data presented in the fields in the GUI 300 displayed on the spreadsheet worksheet 64. The user transfers data to be stored as a record to another tab in the workbook in step S60. In step S70, the user exports the transferred data from the tabbed worksheet of the spreadsheet application 64 to the database 60 via conventional electronic communications methods, including, but not limited to, WAN, LAN, VPN or Internet.

Having described and illustrated the principles of this application by reference to one or more preferred embodiments, it should be apparent that the preferred embodiment(s) may be modified in arrangement and detail without departing from the principles disclosed herein and that it is intended that the application be construed as including all such modifications and variations insofar as they come within the spirit and scope of the subject matter disclosed herein.

1. A computer-implemented method for recording an asset installation, comprising:
obtaining asset data from a remote asset management database via a database obtainer of a remote data exchange system;
obtaining an independent spreadsheet via a spreadsheet obtainer of the remote data exchange system wherein the independent spreadsheet is operable on a portable electronic device;
storing asset data obtained from the remote asset management database in the independent spreadsheet operable on a portable electronic device, the data including at least identifying information for new assets and an employee listing, wherein the independent spreadsheet and the remote asset management database exchange data via a remote data exchange system having a database obtainer and a spreadsheet obtainer;
prepopulating at least one field of the independent spreadsheet with a set of data displayed in a drop down menu when the independent spreadsheet is not operably connected to the remote asset management database and the remote data exchange system;
selecting a variable from the set of data presented in the drop-down menu associated with the at least one field displayed on the independent spreadsheet when the independent spreadsheet is not operably connected to the remote asset management database and the remote data exchange system;
storing the selected variable to a record located in a storage worksheet of the independent spreadsheet when the spreadsheet is not operably connected to the remote asset management database and the remote data exchange system; and
transferring the record from the independent spreadsheet to the spreadsheet obtainer of the remote data exchange system in accordance with controls stored in a control worksheet of the independent spreadsheet that control the manner of exchange of data with the asset management database.
